(19) United States
(12) Patent Application Publication
(10) Pub. No.: US 2019/0260253 A1
(43) Pub. Date: Aug. 22, 2019

(54) STATOR OF AN ELECTRIC MACHINE WITH DOUBLE COIL INSERTION IN THE SLOTS

(71) Applicants: IFP Energies nouvelles, Rueil-Malmaison Cedex (FR); MAVEL S.r.l., Pont Saint Martin (AO) (IT)

(72) Inventors: Luca FAVRE, VALPELLINE (AO) (IT); Benjamin GAUSSENS, RUEIL-MALMAISON CEDEX (FR); Wissam DIB, RUEIL-MALMAISON CEDEX (FR); Julien BOISSON, RUEIL MALMAISON (FR); Davide BETTONI, SETTIMO VITTONE TO ITALY (IT)

(21) Appl. No.: 16/272,049

(22) Filed: Feb. 11, 2019

(30) Foreign Application Priority Data
Feb. 16, 2018 (FR) 18/51.334

(51) Int. Cl. H02K 3/28; H02K 1/16; H02K 3/12; H02K 3/34; H02K 3/487; H02K 21/14

(52) U.S. Cl. CPC H02K 3/28; H02K 1/16; H02K 21/14; H02K 3/345; H02K 3/487; H02K 3/12

(57) ABSTRACT

The present invention relates to a stator of an electrical machine comprising slots (2) and coils (5, 5′) connected to electric phases. The layout of coils (5, 5′) of an electrical phase includes a parallel combination of branches (4), wherein two coils (5, 5′) are combined in series. Furthermore, loops of two coils (5, 5′) of two branches (4) in parallel are inserted in each slot (2).

### CROSS REFERENCE TO RELATED APPLICATIONS

Reference is made to French Application No. 18/51.334 filed Feb. 16, 2018, which is incorporated herein by reference in its entirety.

### BACKGROUND OF THE INVENTION

### Field of the Invention

The present invention relates to the field of electrical machines, in particular (variable-reluctance) magnet-assisted synchro-reluctant electrical machines.

Generally, an electrical machine comprises a stationary part (stator) and a rotating part (rotor) coaxially arranged in one another.

The rotor can consist of a rotor body with a stack of metal sheets arranged on a rotor shaft. These sheets include housings for permanent magnets, and perforations for creating flux barriers allowing the magnetic flux of the magnets to be radially directed towards the stator.

This rotor is generally housed within a stator that carries electrical coils.

Generally, the stator has an annular shape and it is housed inside a tubular support in order to be attached thereto.

This stator comprises a plurality of radial slots open in the direction of the rotor and extending all along the stator periphery. These slots are designed to receive the armature coils that are fed into the stator through the open face of the slots prior to being attached thereto by any known technique.

Upon operation of such an electrical machine, the coils are traversed by an electrical current for generating the magnetic field required to rotate the rotor.

FIG. 1 shows a stator 1 of a variable-reluctance machine driven by three electrical phases A, B and C. Stator 1 has an annular outer shape. Stator 1 comprises thirty-six slots 2 oriented towards the center and an outer ring 3. Slots 2 are generally evenly distributed over the inner circumference of stator 1. The slots are numbered from 1 to 36. Slots 2 house the coils (not shown). This figure schematically shows the phases of the coils passing through the slots. These phases are represented by the letters A, B and C and by a + or − sign indicating which phase passes through the slots.

The layout of the coils in the slots of the stator influences the magnetic fluxes and the performances of the electrical machine. Several coil layouts have therefore been developed.

For example, U.S. Pat. No. 6,417,592 describes a series and parallel layout of the coils providing a large current capacity.

Japanese patent application 2015/061,370 relates to a layout of coils wherein each slot comprises two coils belonging to different phases. Such a layout can be difficult to implement.

FIG. 2 illustrates a layout generally used for the coils of phase A. This example is suited for a stator comprising thirty-six slots as illustrated in FIG. 1. For this layout, phase A comprises three parallel branches 4. Each branch 4 comprises two coils 5 in series. The figures indicated at the ends of coils 5 correspond to the number of the slots (see FIG. 1) through which coils 5 pass. Thus, in this configuration, each slot comprises only one coil.

This type of layout is satisfactory notably because it is easy to install. However, it is desirable to improve the performances of the electrical machine, notably in terms of AC loss reduction (eddy current losses) and thermal cooling (indeed, for this layout, the current densities in the slot can be high, which increases thermal heating).

In order to overcome these drawbacks, the present invention relates to a stator of an electrical machine comprising slots and coils connected to electric phases. The layout of the coils of an electrical phase includes a parallel combination of branches, wherein two coils are combined in series. Furthermore, loops of two coils of two branches in parallel are inserted in each slot. This simple layout allows decreasing the fill factor which enables lower current densities in the slots, that facilitates thermal cooling thereof. Moreover, this layout allows AC losses to be reduced, in view of the double insertion of coils in the slots.

### SUMMARY OF THE INVENTION

The invention relates to a stator of an electrical machine comprising slots for inserting coils, the coils being connected to at least one electrical phase, each electrical phase being connected to a parallel combination of a plurality of branches with each branch having two coils in series with each coil comprising a plurality of loops inserted in two slots. Each slot comprises insertion of the loops of two coils of two branches in parallel.

According to an embodiment, within the parallel combination of the branches, each branch has a branch with an identical layout of the coils.

According to an implementation, each coil comprises between five and fifteen loops, and preferably includes nine loops.

According to an aspect of the invention each loop has a plurality of wires, preferably between three and twenty wires and preferably fourteen wires.

Advantageously, within each branch, the loops of the second coil are inserted in slots neighboring the slots in which the loops of the first coil of the branch are inserted.

Preferably, the loops of the second coil are inserted in the inner slots separating the slots in which the loops of the first coil are inserted.

According to a feature, within each slot, the loops of the coils are positioned in the same direction.

Alternatively, within each slot, the loops of the coils are positioned in opposite directions.

According to an embodiment, the stator comprises a number of slots which are a multiple of twelve.

According to an implementation of the invention, a coil separator is inserted in each slot to separate the coils.

According to an aspect, each slot is lined with insulation paper.

Advantageously, each slot is closed by a blade.

Furthermore, the invention relates to a variable-reluctance electrical machine comprising a rotor and a stator according to one of the above features.

### BRIEF DESCRIPTION OF THE FIGURES

Other features and advantages of the device according to the invention will be clear from reading the description hereafter of embodiments, given by way of non limitative example, with reference to the accompanying figures wherein:

FIG. 1, already described, illustrates a stator of a synchro-reluctant electrical machine;

FIG. 2, already described, illustrates a layout of the coils for a phase of the electrical machine according to the prior art;

FIG. 3 illustrates a layout of the coils for a phase of the electrical machine according to an embodiment of the invention;

FIG. 4 illustrates a layout of the coil loops within a slot according to a first variant embodiment of the invention; and

FIG. 5 illustrates a layout of the coil loops within a slot according to a second variant embodiment of the invention.

### DETAILED DESCRIPTION OF THE INVENTION

The present invention relates to a stator of an electrical machine, which in particular is a variable-reluctance electrical machine.

The stator can have an annular shape and it can be housed inside a tubular support in order to be attached thereto.

The stator comprises a plurality of radial slots which open in the direction of the rotor and extending all along the stator periphery. These slots are designed to receive the armature coils that are fed into the stator through the open face of the slots prior to being attached thereto by any known mechanism.

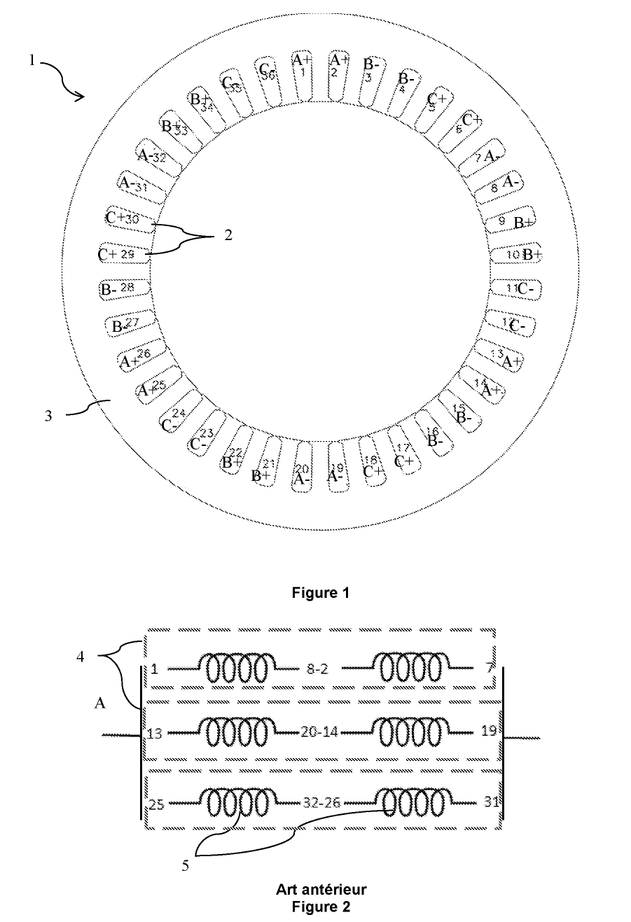

The stator according to the invention can be identical to the stator illustrated in FIG. 1. It can notably comprise thirty-six slots, for a machine with six poles for example. Alternatively, the stator can comprise forty-eight slots, for a machine with eight poles for example. Generally, the stator can comprise a number of slots which are a multiple of twelve. These configurations are particularly suitable for a synchro-reluctant electrical machine.

The stator can be designed for the layout of coils connected to three electric phases. A regular distribution of the phases can be provided within the slots. For example, a pairwise phase alternation can be provided. In other words, two consecutive slots can comprise coils connected to phase A, followed by two consecutive slots with coils connected to phase B, followed by two consecutive slots with coils connected to phase C, which in turn are followed by two consecutive slots with coils connected to phase A and so on.

According to an aspect of the invention, the stator can be made up of a plurality of stacked and assembled flat metal sheets.

The invention relates to a particular layout of the coils in the slots. This layout is similar for each electrical phase.

Within the stator, each electrical phase is connected to a parallel combination of branches. Each branch has a series combination of two coils. Each coil comprises a plurality of loops. In other words, the electrical phase is connected to branches, the branches comprising two coils, and the coils have a plurality of loops (several turns).

According to the invention, each slot of the stator comprises the passage (insertion) of the loops of two coils of two branches which are in parallel. In other words, each slot comprises the passage (insertion) of two coils connected to the same electrical phase and arranged on parallel branches. Loops of two coils in parallel are therefore inserted in a slot. Advantageously, each slot only comprises insertion of two coils in parallel.

This specific coil layout allows reduction of AC losses and an increase of the slot fill factor which enables lower current densities in the slot, facilitating thermal cooling. Fill factor Kb can be defined by a formula of the type:

$$Kb = \frac{Nt \times Nf \times π \times \frac{D}{2}}{S}$$

with Nt the number of turns (loops) in a slot, Nf the number of wires of a loop, D the wire diameter and S the slot surface area.

According to an embodiment of the invention, within the parallel combination of the branches, each branch can have a branch with an identical coil layout. An identical layout is understood to be the series combination of coils passing through the same slots. Thus, in the layout of the coils of an electrical phase, each branch is doubled: there are two branches having coils inserted in the same slots. For example, if a branch comprises a first coil inserted in slots number N and M, and a second coil inserted in slots number P and Q, the combination of branches comprises a second branch having a first coil inserted in slots number N and M, and a second coil inserted in slots number P and Q. This layout enables simplified assembly of the coil in the slots.

According to an implementation of the invention, each coil can comprise between five and fifteen loops which preferably has nine loops. The number of loops can be determined to obtain the desired electric machine performances of torque and power for example.

According to an aspect of the invention, each loop can have a plurality of wires, which notably are copper wires. The copper wires can be coated with a varnish for electrical insulation of the copper wires from one another.

Preferably, each loop comprises between three and twenty wires which preferably is between twelve and sixteen wires. Having, a number of wires in a loop above twenty generates problems for insertion of the loops in the slots.

Advantageously, within each branch, the loops of the second coil can be inserted in slots neighboring the slots in which the loops of the first coil are inserted. In other words, if the loops of the first coil are inserted in slots number N and M, the loops of the second coil are inserted in slots number N+1 or N−1 and M+1 or M−1. Thus, the coils of two consecutive slots of the rotor are connected to the same phase. This configuration is a way to achieve a distributed coil.

Preferably, the loops of the second coil are inserted in the inner slots separating the slots in which the loops of the first coil are inserted. In other words, if the loops of the first coil are inserted in slots number N and M, the loops of the second coil are inserted in slots number N+1 and M−1. This layout allows the coil to be easily obtained.

For regular phase distribution, in the embodiment where the stator comprises a number of slots which are a multiple of twelve, the loops of the first coils of the branches can be spaced out by seven slots. Thus, if the loops of a first coil are inserted in a slot number N, the loops of the first coil are also inserted in slot N+7.

According to an example embodiment combining the last three embodiments described above, the loops of the first coil of a branch can be inserted in slots number N and N+7, and the loops of the second coil of this branch can be inserted in slots number N+1 and N+6.

For the embodiment where the stator comprises a number of slots which are a multiple of twelve, the branches of a combination can be regularly distributed in the slots while being spaced out by twelve slots. For example, if two branches are inserted in a slot number N, two branches are inserted in a slot number N+12, and two branches are inserted in a slot number N+24 (if the stator comprises at least thirty-six slots), and two branches are inserted in a slot number N+36 (if the stator comprises at least forty-eight slots), etc.

According to an implementation of the invention combining the aforementioned embodiments, where the stator comprises thirty-six slots and the coils are connected to three electrical phases so that each electric phase is connected to six branches in parallel, with:
a first branch whose first coil loops are inserted in slots N and N+7, and whose second coil loops are inserted in slots N+1 and N+6,
a second branch identical to the first branch,
a third branch whose first coil loops are inserted in slots N+12 and N+19, and whose second coil loops are inserted in slots N+13 and N+18,
a fourth branch identical to the third branch,
a fifth branch whose first coil loops are inserted in slots N+24 and N+31, and whose second coil loops are inserted in coils N+25 and N+30,
a sixth branch identical to the fifth branch, and
N=1 for electrical phase A, N=3 for electrical phase B and N=5 for electrical phase C.

For an embodiment with a stator comprising forty-eight slots, the combination of a phase can comprise eight branches.

According to an example embodiment, the layout of the first six branches can be similar to the layout described above with, additionally:
a seventh branch whose first coil loops are inserted in slots N+36 and N+43, and whose second coil loops are inserted in slots N+37 and N+42, and
an eighth branch identical to the seventh branch.

According to an embodiment of the invention, the two coils inserted in a slot can be inserted in opposite directions. This embodiment allows AC losses (eddy current losses) to be reduced.

Alternatively, the two coils inserted in a slot can be inserted in identical directions. This variant is easier to implement technically because the coils are inserted identically.

To separate the two coils inserted in a slot, separator can be provided in each slot between the two coils.

According to an aspect of the invention, the slots can be lined with insulation paper in order to provide electrical insulation.

According to a feature of the invention, the slots can comprise a blade allowing the slot to be closed once the coils have been inserted therein. The blade can be substantially V shaped. It can be made from the same material as the insulation paper.

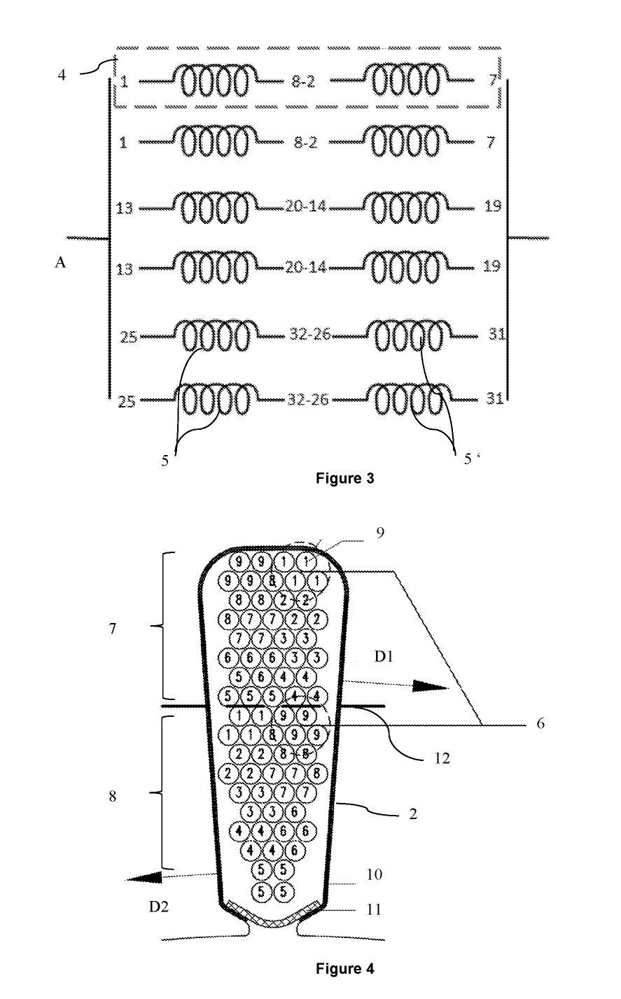

FIG. 3 schematically illustrates, by way of non-limitative example, a coil layout for an electric phase A of a stator according to an embodiment of the invention. In this figure, the numbers at the ends of the coils correspond to the numbers of the slots (see FIG. 1) in which coils 5, 5′ are inserted. The layout of FIG. 3 is suited for the stator illustrated in FIG. 1, which comprises thirty-six slots. This layout includes six parallel branches 4. Each branch 4 comprises a first coil 5 and a second coil 5′.

In this layout, the first two (top down) branches 4 are identical, the third and fourth branches 4 are identical, and the fifth and sixth branches 4 are identical. Indeed, first branch 4 comprises a first coil 5 with a plurality of loops inserted in slots number 1 and 8, and a second coil 5′ with a plurality of loops inserted in slots number 2 and 7, and second branch 4 comprises a first coil 5 with a plurality of loops inserted in slots number 1 and 8, and a second coil 5′ with a plurality of loops inserted slots number 2 and 7.

The third and fourth branches are offset by twelve slots in relation to the first and second branches (slots number 13-20 and 14-19), and the fifth and sixth branches are offset by twelve slots in relation to the third and fourth branches (slots number 25-32 and 26-31).

Furthermore, second coils 5′ are inserted in slots neighboring those in which first coils 5 are inserted. Moreover, they are located inside the space between the slots in which first coil 5 is inserted.

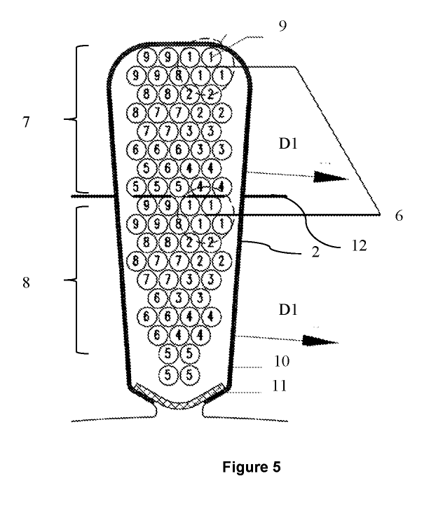

FIGS. 4 and 5 schematically illustrate, by way of non-limitative example, the filling of a slot 2 by the coil wires according to two variant embodiments. Wires 9 of a first coil of a first branch are grouped together in the upper part 7 of slot 2 and wires 9 of a second coil of a second branch are grouped together in the lower part 8 of slot 2. In these figures, numbers 1 to 9 written in wires 9 correspond to the numbers of loops 6 passing through slot 2. Thus, each loop 6 comprises four wires 9 of circular section. Examples of loops 6 are shown by circles in dotted line.

Furthermore, these figures also show:
separation 12 between the two coils,
insulation paper 10 of slot 2, and
V-shaped closure 11 closing slot 2.

The first variant of FIG. 4 corresponds to a variant where loops 6 of the coil in upper part 7 of slot 2 are positioned in a direction D1 opposite direction D2 of coil loops 6 in lower part 8 of slot 2. This opposite direction translates notably into an opposite layout of loops 6: loops numbered 1 to 4 that were in the right-hand corner of upper part 7 are in the left-hand corner in lower part 8, and loops number 9 to 6 that were in the left-hand corner in upper part 7 are in the right-hand corner in lower part 8.

The second variant of FIG. 5 corresponds to a variant where coil loops 6 in upper part 7 of slot 2 are positioned in a direction D1 identical to the direction D1 of coil loops 6 in lower part 8 of slot 2. This identical direction translates notably into a substantially identical layout of loops 6: loops number 1 to 4 that were in the right-hand corner in upper part 7 are in the right-hand corner in lower part 8, and loops number 9 to 6 that were in the left-hand corner in upper part 7 are in the left-hand corner in lower part 8.

Furthermore, the invention relates to an electrical machine, in particular a (variable-reluctance) synchro-reluctant machine, comprising a rotor and a stator according to any one of the variant combinations described above. This rotor is generally housed inside the stator.

The rotor can consist of a rotor body with stacks of metal sheets arranged on a rotor shaft. These sheets comprise housings for permanent magnets and perforations for creating flux barriers allowing the magnetic flux of the magnets to be radially directed towards the stator.

### Numerical Example

The features and advantages of the invention will be clear from reading the application example hereafter.

For this example, a stator is considered with thirty-six slots as illustrated in FIG. 1, with a coil layout according to the embodiment of the invention illustrated in FIG. 3.

Furthermore, the stator comprises slots with a surface area of 138 mm². The diameter of the wires is D=0.56 mm with each coil having 9 loops. Therefore each slot comprises 18 loops, and each loop has 14 wires in parallel.

For this configuration, fill factor Kb reaches 0.45 (for a slot with a single coil, fill factor Kb ranges between 0.4 and 0.45), which allows having lower current densities in the slot which formulates thermal cooling thereof.

1.-13. (canceled)

14. A stator of an electrical machine comprising slots for inserting coils, the coils being connected to at least one electrical phase, each electrical phase being connected to a parallel connection of branches, each branch including two coils in series, each coil comprising loops inserted in two slots, wherein each slot comprises insertion of the loops of the two coils of two branches connected in parallel.

15. A stator of an electrical machine as claimed in claim 14 wherein, within the parallel connection of the branches, each branch has an identical layout of the coils.

16. A stator of an electrical machine as claimed in claim 14, wherein each coil of the two coils comprises between five and fifteen loops of wire.

17. A stator of an electrical machine as claimed in claim 16 having nine loops.

18. A stator of an electrical machine as claimed in claim 15, wherein each coil of the two coils comprises between five and fifteen loops of wire.

19. A stator of an electrical machine as claimed in claim 18 having nine loops.

20. A stator of an electrical machine as claimed in claim 14, wherein each loop comprises between three and twenty wires.

21. A stator of an electrical machine as claimed in claim 20 comprising fourteen wires.

22. A stator of an electrical machine as claimed claim 14 wherein, within each branch, loops of a second coil are inserted in neighboring slots in which loops of a first coil of the branch are inserted.

23. A stator of an electrical machine as claimed in claim 22, wherein the loops of the second coil are inserted in inner slots separated from slots in which the loops of the first coil are inserted.

24. A stator of an electrical machine as claimed in claim 14 wherein, within each slot, the loops of the coils are positioned in a same direction of current flow.

25. A stator of an electrical machine as claimed in claim 14 wherein, within each slot the loops of the coils are positioned in opposite directions of current flow.

26. A stator of an electrical machine as claimed in claim 14, wherein the stator comprises slots in multiples of twelve.

27. A stator of an electrical machine as claimed in claim 14, wherein a separator is inserted in each slot to separate the coils.

28. A stator of an electrical machine as claimed in claim 14, wherein each slot is lined with insulation paper.

29. A stator of an electrical machine as claimed in claim 14, wherein each slot is closed by a closure of an opening in the slot.

30. A variable-reluctance electrical machine comprising a rotor and a stator as claimed in accordance with claim 14.

31. A variable-reluctance electrical machine comprising a rotor and a stator as claimed in accordance with claim 15.

32. A variable-reluctance electrical machine comprising a rotor and a stator as claimed in accordance with claim 16.
